(19) United States
(12) Patent Application Publication
(10) Pub. No.: US 2026/0195132 A1
(43) Pub. Date: Jul. 9, 2026

(54) OCCASIONALLY YIELDING CONTROL TO OTHER THREADS

(71) Applicant: NVIDIA Corporation, Santa Clara, CA (US)

(72) Inventors: Simon Cooksey, Canterbury (GB); Gonzalo Brito Gadeschi, Munich (DE); Sean Treichler, Piedmont, CA (US); Richard Johnson, Chapel Hill, NC (US)

(21) Appl. No.: 19/014,706

(22) Filed: Jan. 9, 2025

(51) Int. Cl. G06F 9/30; G06F 8/41

(52) U.S. Cl. CPC G06F 9/3009; G06F 8/447

(57) ABSTRACT

Code running on a processing unit can retain a hold on an active thread thereby preventing another thread running on the processing unit from executing. This can occur when the code requests more threads to be executed than the processing unit can give forward progress to, e.g., more threads than can be run simultaneously. Inserting the conventional yield instruction can lead to processing inefficiency such that the yield instruction can be executed more times than necessary thereby leading to an inefficiency in processing cycles of the processing unit performing the thread-switching routines. A yield occasionally instruction can be inserted into the code instead of the yield instruction. The yield occasionally can limit the times a yield instruction is executed thereby improving the efficiency of the processing cycles. The yield occasionally instruction can be used in non-terminating regions of the code, where the forward progress of other threads cannot be guaranteed.

### TECHNICAL FIELD

This application is directed, in general, to directing the operation of a processing unit and, more specifically, to directing the execution of threads of the processing unit.

### BACKGROUND

There are various types of processing units available, such as central processing units, graphics processing units, and other types of processing units. Many of these processing units allow for the execution of more than one thread of execution at a time. Code may be executed by a thread could a block processing so that another thread cannot proceed. Being able to control the blocking of a thread by another thread can be beneficial during the processing of multiple threads.

### BRIEF DESCRIPTION

Reference is now made to the following descriptions taken in conjunction with the accompanying drawings, in which:

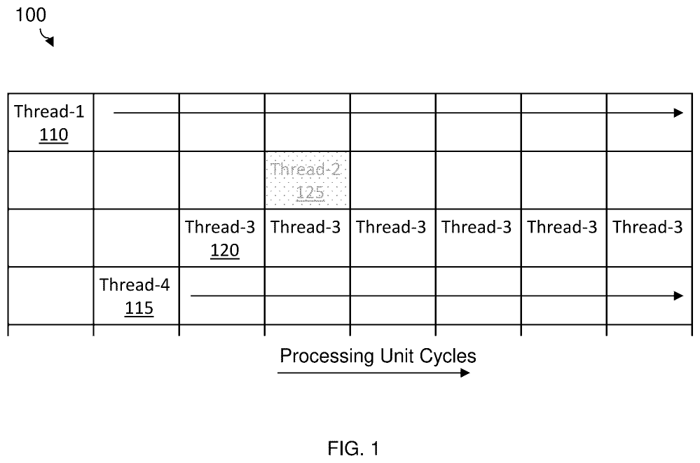

FIG. 1 is an illustration of a diagram of an example multi-threaded processing unit;

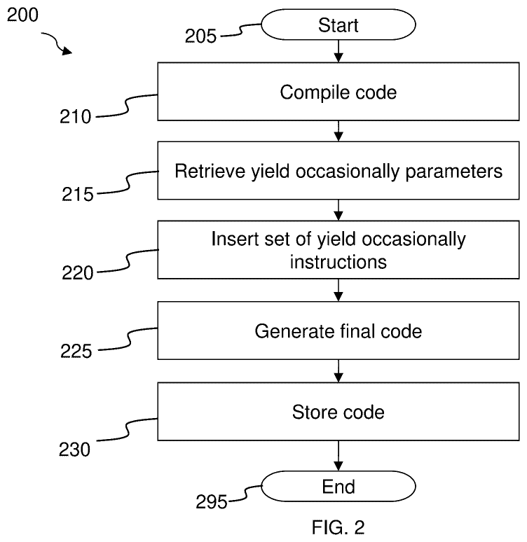

FIG. 2 is an illustration of a block diagram of an example method for inserting a yieldocc instruction;

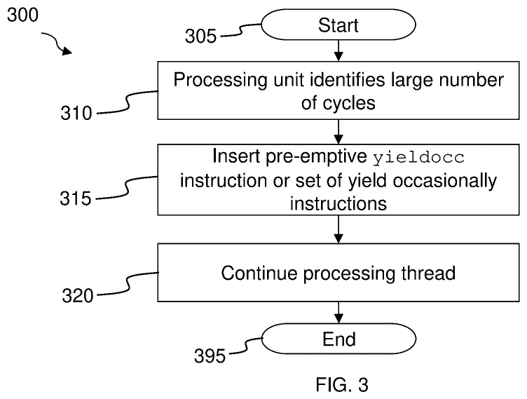

FIG. 3 is an illustration of a block diagram of an example method for a processing unit to insert a yieldocc instruction;

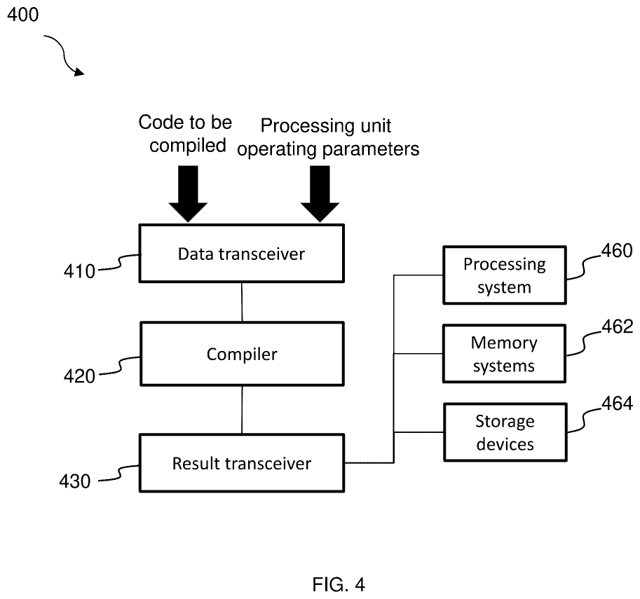

FIG. 4 is an illustration of a block diagram of an example yieldocc system; and

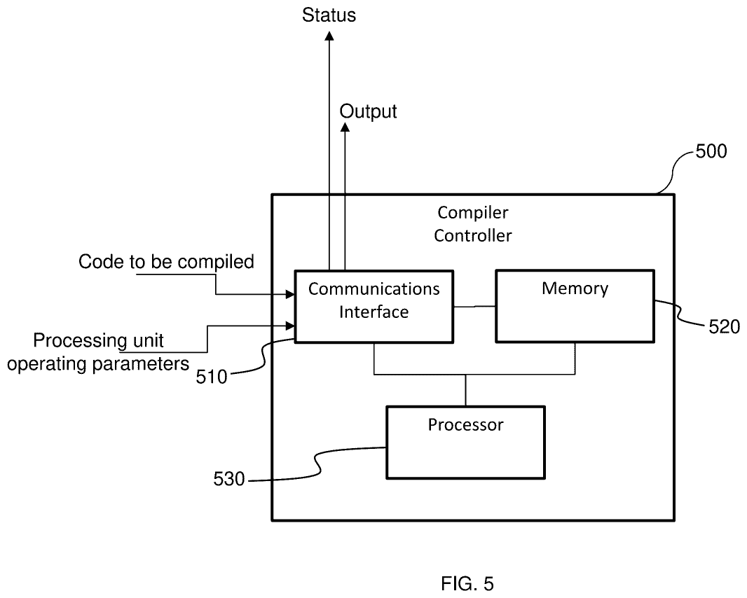

FIG. 5 is an illustration of a block diagram of an example of a yieldocc controller according to the principles of the disclosure.

### DETAILED DESCRIPTION

Computing systems can be implemented using one or more processing units that can execute code. A processing unit can be a central processing unit (CPU), a graphics processing unit (GPU), a single instruction multiple data (SIMD) unit, or other types of processing units. Many of these processing units have the ability to initiate and process more than one thread of execution at a time. As the threads execute, e.g., perform actions as directed by code, there can occur times when one thread can block another thread from executing. Some processing units have a method to automatically switch from the thread that is executing regardless of what action the thread is performing or what code the thread is executing. Other processing units may not have an automatic process to yield processing control.

In some aspects, threads on some GPUs, for example, do not automatically allow other threads to get a turn executing unless there is an explicit yield instruction in the code. Not all programming languages have a process to implement a yield instruction or the inclusion of a yield instruction in the code can cause inefficiency in the processing cycles of the processing unit. To support programming languages on the targeted processing unit, a forward progress guarantee may be needed. A forward progress guarantee is when one thread of execution cannot indefinitely block a different thread from taking execution steps under certain conditions. Some languages (for example, C++) have defined these conditions as atomic operations, such as loads, stores, fences, or other atomic operations, volatile operations, input/output operations, or other operations.

To successfully support these programming languages, compilers of code supporting the processing unit can insert a yield instruction into code segments so that threads that may otherwise execute indefinitely are paused to allow other threads to take an execution turn, as specified by the programming languages. In some aspects, the compiler cannot determine with 100% certainty that a code segment will yield processing control or execute indefinitely (e.g., termination of the code is uncertain), so the compiler may be forced to insert more yield instructions throughout the code than desired. These additional yield instructions can cause inefficiencies when the segments are executed such as delays or pauses in execution at a time when the delay or pause is not needed on the thread. The typical yield instruction therefore can result in performance overhead and may not be desirable for all situations.

This disclosure presents a scheme to control blocking of threads by another executing thread. For example, the control scheme can use an instruction or instructions that limits or reduces yielding compared to yielding every time a conventional yield operation is encountered. The instruction or set of instructions, referred to as a set of one or more yield occasionally instructions and represented herein as a yieldocc instruction, can be implemented by the compiler when compiling code targeting a processing unit. The yieldocc instruction can be implemented using one or more code instructions, compiler instructions, or processing unit instructions. In some aspects, the code can spawn a greater number of threads than can be executed simultaneously by the processing unit. Occasionally yielding processing control can be important on processing units that have a greater number of spawned threads than can be executed simultaneously. It is the excess threads that may have a forward guarantee of execution progress that should be satisfied.

For a conventional yield operation, the thread in which the instruction is executing will yield to other threads of the processing unit each time the yield operation is encountered. For example, if the code has a small loop of code, a yield operation placed inside the loop can result in unnecessary overhead and delays in executing the looped code. In some aspects, the yield operation can be performed using one or more yield instructions of the programming language of the code block or of the processing unit being targeted by the compilation of the code block. In some aspects, if one or more yield instructions are not available, the yield operation can be simulated using programming instructions within the code block, compilation instructions of the compiler, or processing unit instructions of the targeted processing unit. Since the yield operation can be performed by one or more yield instructions or through a simulation of other instructions, further herein of this disclosure, the term one or more yield instructions is used as an example to demonstrate the yield operation in conjunction with the yield occasionally operation.

By replacing the yield instruction with a yieldocc instruction, rather than yielding each time the yield instruction is encountered, yielding can occur at a yield interval (e.g., occasionally). The looped code can maintain a higher efficiency of operation while occasionally yielding which allows the programming language to be considered a valid implementation. For example, C++ programming constructs specify that each thread is guaranteed a turn at execution (e.g., forward progress for every thread), where frequency and timing of the forward progress is determined separately. The compiler can produce code that is compliant with the programming language constructs while reducing the performance hit of doing so in a substantial portion of the loop iterations. The overhead and performance impact of yielding is reduced and amortized over many loop iterations.

The yieldocc instruction can be implemented by the compiler using different techniques. In some aspects, the yieldocc instruction can be implemented as a counter which decreases each time the yieldocc instruction is called. The initial value of the counter can be a default value, set by the processing unit, set by the programming code, or determined by the compiler using a decision algorithm. When the counter is reduced to zero, the yield instruction can be executed and the counter can be reset to its initial value. For example, a pessimistic pre-emptive yield can be implemented by inserting the yieldocc instruction into code and specify that a yield will occur after a specified number of cycles has passed. Pseudocode demonstrating this is presented in Code Listing 1:
Code Listing 1: Example pseudocode demonstrating counter algorithm int yield_counter=INITIAL_VALUE/* e.g., 1000000 */ /* set by default, by code, or by the processing unit operating parameters */
LOOP:
   /* includes an operation that the programming language specifies must allow other threads to make forward progress */
   yieldocc yield_counter
   /* continue loop */
yieldocc(yield_counter) /* Example implementation */
   if (yield_counter<=0)
      yield( );
      yield_counter=INITIAL_VALUE;
   else yield_counter--

In some aspects, the yieldocc instruction can be implemented using a yield every N algorithm. N can represent a loop-type counter as in the aspect above, or N can represent a specified amount of time, such as a number of milliseconds, or other instructions, data, or code. For example, N can represent every 500 milliseconds, the number of times a fence instruction is encountered, the number of times an even data value is encountered, or other types of encounters within the execution of the code. N can be defaulted to a value, set by the compiler using a decision algorithm, set by the processing unit, or set by the code. Pseudocode demonstrating an example of this is presented in Code Listing 2:
Code Listing 2: Example pseudocode demonstrating an every N algorithm
/* The loop part of Code Listing 1 applies here. Below is a new implementation of the yieldocc instruction. */
yieldocc (shard_yield_counter)
   if (shard_yield_counter<=0)
      shard_yield_counter=INITIAL_VALUE
      yield;
      else shard_yield_counter--

Code Listing 2 uses the concept of shards (which is a subset of threads, for example, the set of threads needing to move forward in execution. For example, Code Listing 2 can be modified to state that once there are more threads needing execution than can be run simultaneously, then the yieldocc instruction will check whether it is at an interval to perform a yield. This can cause the yield instruction to be delayed by a counter interval and also if there are no pending threads waiting for execution, e.g., specifying a two-step decision algorithm.

In some aspects, the yieldocc instruction can be implemented using a stochastic algorithm. For example, the yieldocc instruction can check a randomly generated result to determine whether the yield instruction is executed. For example, using a 1 in 100 chance to perform the yield instruction. The random algorithm to be used can be defaulted to a value, set by the compiler using a decision algorithm, set by the processing unit, or set by the code.

In some aspects, the yieldocc instruction can be implemented using a backoff algorithm. For example, a counter or N parameter (e.g., backoff value) can be specified and each time the counter or N parameter triggers the yield instruction, the counter or N parameter is incremented according to an increment algorithm. For example, the increment algorithm can double the counter, multiply by 10, exponential increase, or use various other types of increment algorithms. The counter, N parameter, and the increment algorithm to be used can be specified by default, set by the compiler using its decision algorithm, set by the processing unit, or set by the code. In some aspects, the increment algorithm can specify an N-threshold parameter at which the counter or N parameter is no longer increased. In some aspects, the increment algorithm can reset the counter or N parameter to its initial value after reaching the threshold parameter.

In some aspects, the yieldocc instruction can be implemented using hardware detection techniques. For example, the hardware can be instructed to detect tight loops and to automatically insert a yield instruction after a specified number of loop iterations, e.g., similar to the counter method described above.

The decision algorithm can be determined by the compiler using one or more yield parameters provided by the code and the operating parameters of the processing unit. For example, the code can provide a compiler direction to use a constant counter or a random chance to execute a yield instruction. In some aspects, the compiler can use an input from a machine learning system to determine the decision algorithm to implement. For example, the machine learning system can analyze a code block, code segment, code library, or other code portion, and estimate the type of yieldocc instruction that can minimize the processing overhead of yield instructions. For example, a simple tight loop of code may be better served using a constant counter decision algorithm, whereas a complex code block may be better served using a count of the number of times a specific instruction is encountered in the code block.

In some aspects, the yieldocc instruction can be implemented at a processing unit apparatus, while not involving a compiler. The processing unit can have a thread management system, capable of executing at least one more thread than the processing unit can process simultaneously. The processing unit can include a code execution system, capable of analyzing executing code on each thread of the thread management system and determining if a locking thread of the thread management system is exceeding a specified number of loops while not releasing thread control. The processing unit can include a code system, capable of inserting a yieldocc instruction at a position within a code block being executed by the locking thread, wherein the yieldocc instruction will occasionally execute a yield instruction on the locking thread, where occasionally is determined by a decision algorithm. In some aspects, the processing unit apparatus can specify that the yieldocc instruction uses a processing unit operating parameter or a yield parameter specified within the code block to determine the algorithm to utilize with the yieldocc instruction.

Turning now to the figures, FIG. 1 is an illustration of a diagram of an example multi-threaded processing unit 100. Multi-threaded processing unit 100 demonstrates a processor with four threads spawned and that can process one thread at a time. This diagram is for illustrative purposes as processing units can have various number of threads execute simultaneously.

A thread-1 110 executes at a first processing cycle. A thread-4 115 executes at a second processing cycle. A thread-3 120 executes at a third processing cycle. A thread-2 125 should execute at a fourth processing cycle. Thread-2 125 does not execute due to thread-3 120 being in a loop that does not allow for a yield of execution. Thread-2 125 does not have forward progress as guaranteed by some programming languages. Inserting a yield instruction into the code being executed by thread-3 120 could result in unnecessary processing cycles given up to the yield process. A yieldocc instruction can resolve this issue by causing a yield event to occur occasionally rather than every time through the looping code block.

FIG. 2 is an illustration of a block diagram of an example method 200 for inserting a yieldocc instruction. Method 200 can be performed on a computing system, for example, yieldocc system 400 of FIG. 4 or yieldocc controller 500 of FIG. 5. The computing system can be one or more processors in various combinations (e.g., CPUs, GPUs, SIMDs, or other types of processors), a data center, a cloud environment, a server, a laptop, a mobile device, a smartphone, a PDA, or other computing system capable of compiling code for a targeted processing unit. Method 200 can be encapsulated in software code or in hardware, for example, an application, code library, code module, dynamic link library, module, function, RAM, ROM module, and other software and hardware implementations. The software can be stored in a file, database, or other computing system storage mechanism. Method 200 can be partially implemented in software and partially in hardware. Method 200 can perform the steps for the described processes, for example, identify potentially non-terminating regions of code and insert a yieldocc instruction.

Method 200 starts at a step 205 and proceeds to a step 210. In step 210, the compiler receives code to be compiled as well as a targeted processing unit. Processing units can vary as to how they handle general yield instructions, including the possibility of not invoking or providing for a yield type of instruction. Knowing the operating parameters of the processing unit can assist the compiler in estimating where in the code that a yieldocc instruction should be positioned.

In a step 215, one or more yield parameters for the yieldocc instruction can be identified or retrieved. In some aspects, the yield parameters can be specified by a default value supplied by the compiler or the processing unit. In some aspects, the one or more yield parameters can be specified by the code to be compiled (e.g., embedded instructions or compiler hints) or by the operating parameters received from the processing unit. In some aspects, the one or more yield parameters can be provided as an output of a machine learning system that has analyzed the code block being compiled.

For example, the yield parameters can specify the type of yieldocc to implement (e.g., the decision algorithm to use with then yieldocc instruction), such as a counter, an N value, a random check, an algorithm to use to verify whether a yield is needed, or other types of implementation details. In some aspects, the algorithms used can be code-specific, such as counting the number of times through a loop of code. In some aspects, the algorithm can be system-related, such as counting the number of spawned threads above the number of threads that can be run simultaneously on the processing unit and using that value to determine how often the yield instruction is executed.

In a step 220, once the compiler determines at what position in a code block that a yieldocc should be placed, the yieldocc instruction is positioned in the compiled code block using the yield parameter specification as identified or specified in step 215. The code block, where the one or more positions are located, is a non-terminating region of code or a region of code that is unknown to terminate, e.g., termination of the code is uncertain. Such that, the compiler cannot be certain that the code block will allow a pause in its thread of execution to allow other blocked threads to execute on the processing unit, e.g., guaranteeing forward progress of other threads requesting execution cycles of the processing unit.

In a step 225, the final compiled code, e.g., the compilation of code, is generated. In a step 230, the final compiled code is stored appropriately, for example, in a memory location, on a storage device, in a database, in a data center, in a cloud environment, in a processing unit cache, or in various other types of storages systems. Method 200 ends at a step 295.

FIG. 3 is an illustration of a block diagram of an example method 300 for a processing unit to insert a yieldocc instruction. Method 300 can be performed on a computing system, for example, yieldocc system 400 of FIG. 4 or yieldocc controller 500 of FIG. 5. The computing system can be one or more processors in various combinations (e.g., CPUs, GPUs, SIMDs, or other types of processors), a data center, a cloud environment, a server, a laptop, a mobile device, a smartphone, a PDA, or other computing system capable of executing threads in simultaneously, including executing in parallel or at least partially in parallel. Method 300 can be encapsulated in software code or in hardware, for example, an application, code library, code module, dynamic link library, module, function, RAM, ROM module, and other software and hardware implementations. The software can be stored in a file, database, or other computing system storage mechanism. Method 300 can be partially implemented in software and partially in hardware. Method 300 can perform the steps for the described processes, for example, inserting a yieldocc instruction in an executing thread.

Method 300 starts at a step 305 and proceeds to a step 310. In step 310, the processing unit, during the execution of threads, can identify whether a code loop of a code block is encountered. In some aspects, the processing unit can use a counter to identify when a large number of cycles has been utilized by a thread. In a step 315, the processing unit can pre-emptively insert a yieldocc instruction into the code being executed by the thread to allow the thread to initiate a yield instruction occasionally, e.g., as specified by the decision algorithm in use by the yieldocc instruction. In some aspects, the processing unit can specify the decision algorithm to use, such as a counter, a timer, or other types of decision algorithms. In some aspects, the decision algorithm can be defaulted, such as to a counter set to 1,000,000 or some other value. In some aspects, the compiled code can include instructions for how to implement the yieldocc instruction for the processing unit to follow. In a step 320, the thread can continue processing as specified by the code, including evaluating a yieldocc inserted into the thread's code block. Method 300 ends at a step 395.

FIG. 4 is an illustration of a block diagram of an example yieldocc system 400. Yieldocc system 400 can be implemented in one or more computing systems or one or more processors. In some aspects, yieldocc system 400 can be implemented using a yieldocc controller such as yieldocc controller 500 of FIG. 5. Yieldocc system 400 can implement one or more aspects of this disclosure, such as method 200 of FIG. 2 or at least a part of method 300 of FIG. 3.

Yieldocc system 400, or a portion thereof, can be implemented as an application, a code library, a dynamic link library, a function, a module, a header file, other software implementation, or combinations thereof. In some aspects, yieldocc system 400 can be implemented in hardware, such as a ROM, a graphics processing unit, or other hardware implementation. In some aspects, yieldocc system 400 can be implemented partially as a software application and partially as a hardware implementation. Yieldocc system 400 is a functional view of the disclosed processes and an implementation can combine or separate the described functions in one or more software or hardware systems.

Yieldocc system 400 includes a data transceiver 410, a compiler 420, and a result transceiver 430. The output, e.g., the final compiled code, can be communicated to a data receiver, such as one or more of a processing system 460 (one or more combinations of processors or processing cores), one or more memory systems 462, or one or more storage devices 464. The output can be executed on a targeted processing unit, where a yieldocc instruction is implemented in the code.

In some aspects, the results of the yieldocc system 400, such as those communicated to the one or more processing systems 460, one or more storage devices 464, or one or more memory systems 462, can be used as an input into another process or system, for example, being used as an input to other compiled code, such as a code library.

Data transceiver 410 can receive the input parameters, including the code to be compiled, one or more yield parameters, and operating parameters of the processing unit. In some aspects, data transceiver 410 can be part of compiler 420.

Result transceiver 430 can communicate one or more outputs, to one or more data receivers, such as processing systems 460, one or more memory systems 462, one or more storage devices 464, or other related systems, whether located proximate result transceiver 430 or distant from result transceiver 430. Data transceiver 410, compiler 420, and result transceiver 430 can be, or can include, conventional interfaces configured for transmitting and receiving data. Data transceiver 410, compiler 420, or result transceiver 430 can be implemented as software components, for example, a virtual processor environment, as hardware, for example, circuits of an integrated circuit, or combinations of software and hardware components and functionality. The functionality described for these components remains intact regardless of how the functionality is implemented.

Compiler 420 (e.g., one or more processors such as processor 530 of FIG. 5) can implement the analysis and algorithms as described herein utilizing the input parameters. Compiler 420 can be one or more of a multicore processor, a multiprocessor system, or a streaming multiprocessor. Compiler 420 can be implemented by a central processing unit (CPU), a graphics processing unit (GPU), or other types of processors.

A memory or data storage system of compiler 420 (such as a core cache, L1 cache, L2 cache, or other memory systems) can be configured to store the processes and algorithms for directing the operation of Compiler 420. Compiler 420 can include a processor that is configured to operate according to the analysis operations and algorithms disclosed herein, and an interface to communicate (transmit and receive) data.

FIG. 5 is an illustration of a block diagram of an example of a yieldocc controller 500 according to the principles of the disclosure. Yieldocc controller 500 can be stored on one computer or multiple computers. The various components of yieldocc controller 500 can communicate via wireless or wired conventional connections. A portion or a whole of yieldocc controller 500 can be located at one or more locations. In some aspects, yieldocc controller 500 can be part of another system (e.g., processor, core, server, or other systems), and can be integrated with one device, such as a part of a processing system. Yieldocc controller 500 represents a demonstration of the functionality employed for the disclosure, and implementations can use a variety of devices, for example, circuits of a processor, dedicated processors, virtual systems, servers, other computing or processing systems, be in software or hardware, or various combinations thereof.

Yieldocc controller 500 can be configured to perform the various functions disclosed herein including receiving input parameters and generating results from execution of the methods and processes described herein, such generating a final compiled code that as yieldocc instruction inserted at determined positions in the code. Yieldocc controller 500 includes a communications interface 510, a memory 520, and a processor 530.

Communications interface 510 is configured to transmit and receive data. For example, communications interface 510 can receive the input parameters. Communications interface 510 can transmit the output or interim outputs. In some aspects, communications interface 510 can transmit a status, such as a success or failure indicator of yieldocc controller 500 regarding receiving the various inputs, transmitting the generated outputs, or producing the results.

In some aspects, processor 530 can perform the operations as described by compiler 420. Communications interface 510 can communicate via communication systems used in the industry. For example, wireless or wired protocols can be used. Communication interface 510 is capable of performing the operations as described for data transceiver 410 and result transceiver 430 of FIG. 4. Memory 520 can be configured to store a series of operating instructions that direct the operation of processor 530 when initiated, including supporting code representing the algorithm for implementing the yieldocc instruction at one or more positions within the provided code. Memory 520 is a non-transitory computer-readable medium. Multiple types of memory can be used for the data storage systems and memory 520 can be distributed.

Processor 530 can be one or more processors. Processor 530 can be a combination of processor types, such as a CPU, a GPU, a single instruction multiple data (SIMD) processor, or other processor types. Processor 530 can be configured to produce the output, one or more interim outputs, and statuses utilizing the received inputs. Processor 530 can determine the output using parallel processing. Processor 530 can be an integrated circuit. In some aspects, processor 530, communications interface 510, memory 520, or various combinations thereof, can be an integrated circuit. Processor 530 can be configured to direct the operation of yieldocc controller 500. Processor 530 includes the logic to communicate with communications interface 510 and memory 520, and perform the functions described herein. Processor 530 is capable of performing or directing the operations as described by compiler 420 of FIG. 4.

For example, in some aspects, yieldocc system 400 or yieldocc controller 500 can perform an analysis of code and determine that termination is not guaranteed, and insert a yieldocc instruction with an appropriate algorithm at one or more positions within the code for regions that are not guaranteed to terminate. The code blocks, where the one or more positions are located, are non-terminating regions of code or regions of code that are unknown to terminate, e.g., termination of the code block is uncertain. In some aspects, yieldocc system 400 or yieldocc controller 500 can be part of another system. For example, in some aspects, yieldocc system 400 or yieldocc controller 500 can be part of a language system, a programming system, a code assist system (including artificial intelligence code processing systems), a processing unit, or other types of computing systems. In some aspects, yieldocc system 400 or yieldocc controller 500 can be part of a machine learning system, where the analysis for determining where to position a yieldocc instruction in the code and what type of algorithm to use with the yieldocc instruction is part of the machine learning processes.

In some aspects, a processing unit system can include: (1) a thread management system, capable of executing at least one more thread than a processing unit is able to process simultaneously, (2) a code execution system, capable of analyzing, during a runtime processing of the processing unit, a code block on at least one thread of the thread management system to determine if the code block is causing a locking thread of the thread management system, wherein the locking thread exceeds a specified number of loops or a specified number of processing cycles while not releasing thread control, and (3) a runtime modifier system, capable of inserting a set of one or more yield occasionally instructions at a position within the code block of the locking thread, wherein the set of one or more yield occasionally instructions will occasionally execute a yield instruction on the locking thread, as determined by a decision algorithm. In some aspects, the processing unit system can specify that the set of one or more yield occasionally instructions can be implemented using a yieldocc instruction with yield parameters. In some aspects, the processing unit system can specify that the set of one or more yield occasionally instructions can be simulated with a set of processing unit instructions.

A portion of the above-described apparatus, systems or methods may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more of other processor types, or a combination thereof. The digital data processors and computers can be located proximate to each other, proximate to a user, in a cloud environment, a data center, or located in a combination thereof. For example, some components can be located proximate to the user, and some components can be located in a cloud environment or data center.

The GPUs can be embodied on one semiconductor substrate, included in a system with one or more other devices such as additional GPUs, a memory, and a CPU. The GPUs may be included on a graphics card that includes one or more memory devices and is configured to interface with a motherboard of a computer. The GPUs may be integrated GPUs (iGPUs) that are co-located with a CPU on one chip. Configured or configured to means, for example, designed, constructed, or programmed, with the necessary logic and/or features for performing a task or tasks.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions, and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

Aspects disclosed herein include:

A. A method, including (1) compiling code for a targeted processing unit, wherein the code spawns a greater number of threads than can be executed simultaneously by the targeted processing unit, (2) inserting a set of one or more yield occasionally instructions into the code during compilation when a termination of the code is uncertain, wherein the set of one or more yield occasionally instructions cause a thread in which the set of one or more yield occasionally instructions are executing to perform a yield operation at a yield interval as directed by a yield parameter, and (3) generating, using the compiling code and the set of one or more yield occasionally instructions, a final compiled code for the targeted processing unit.

B. A processing unit, including (1) a thread management system, capable of executing at least one more thread than the processing unit is able to process simultaneously, (2) a code execution system, capable of analyzing execution of a code block on each thread of the thread management system and determining if a locking thread of the thread management system exceeds a specified number of loops or a specified number of processing cycles while not releasing thread control, and (3) a code modification system, capable of inserting a set of one or more yield occasionally instructions at a position within the code block being executed by the locking thread, wherein the set of one or more yield occasionally instructions will occasionally perform a yield operation on the locking thread, as determined by a decision algorithm.

C. A system, including (1) a processing unit capable of executing compiled code blocks using more threads than the processing unit is capable of running simultaneously, and (2) a compiler, capable of compiling code to run on the processing unit, receiving operating parameters of the processing unit, and inserting a set of one or more yield occasionally instructions into the code at positions determined by the compiler, wherein the operating parameters indicate that the processing unit does not guarantee forward progress for each thread, the set of one or more yield occasionally instructions specifies a yield operation is to be performed at a yield interval, and code blocks where the positions are located are non-terminating regions or regions that are uncertain to terminate.

D. A computer program product having a series of operating instructions stored on a non-transitory computer-readable medium that directs a compiler when executed thereby to perform operations for compiling code, the operations including (1) receiving operating parameters of a processing unit, wherein the processing unit is capable of processing more threads than can be run simultaneously on the processing unit, (2) compiling the code for the processing unit, wherein the code will spawn a greater number of threads than can be executed simultaneously by the processing unit, (3) inserting a one or more yieldocc instructions into the code during compilation when the code is known to not terminate its processing thread, or the code is uncertain to terminate its processing thread, wherein the one or more yieldocc instructions cause a thread in which the one or more yieldocc instructions are executing to execute a yield operation at a yield interval as directed by a yield parameter, and (4) generating, using an output of the compiling and the inserting, a final compiled code capable of being executed on the processing unit.

E. A processing unit system, including (1) a thread management system, capable of executing at least one more thread than a processing unit is able to process simultaneously, (2) a code execution system, capable of analyzing, during a runtime processing of the processing unit, a code block on at least one thread of the thread management system to determine if the code block is causing a locking thread of the thread management system, wherein the locking thread exceeds a specified number of loops or a specified number of processing cycles while not releasing thread control, and (3) a runtime modifier system, capable of inserting a set of one or more yield occasionally instructions at a position within the code block of the locking thread, wherein the set of one or more yield occasionally instructions will occasionally perform a yield operation on the locking thread, as determined by a decision algorithm.

F. A method, including (1) compiling code for a targeted processing unit, wherein the code spawns a greater number of threads than can be executed simultaneously by the targeted processing unit and the compiling code includes one or more instructions in one of the threads that cause the one of the threads to conditionally perform a yield operation at a yield interval as directed by a yield parameter, and (2) generating, using the compiling code and the one or more instructions, a final compiled code for the targeted processing unit.

Each of the disclosed aspects in A, B, C, D, and F can have one or more of the following additional elements in combination. Element 1: wherein the set of one or more yield occasionally instructions is a single code instruction. Element 2: wherein the yield operation is simulated by code when not supported by the targeted processing unit. Element 3: wherein the yield parameter is specified by a decision algorithm. Element 4: wherein the yield parameter specifies the set of one or more yield occasionally instructions execute the yield operation after a specified number of times the set of one or more yield occasionally instructions are executed. Element 5: wherein a count of the specified number is reset to zero when the yield operation is executed. Element 6: wherein the yield parameter specifies the set of one or more yield occasionally instructions execute the yield operation after a specified amount of time has elapsed. Element 7: wherein the yield parameter specifies the set of one or more yield occasionally instructions execute the yield operation after a specified number of times a specified instruction is encountered in the code. Element 8: wherein the yield parameter specifies the set of one or more yield occasionally instructions execute the yield operation when a randomly generated result satisfies the yield parameter. Element 9: wherein the yield parameter specifies the set of one or more yield occasionally instructions execute the yield operation after a backoff value is satisfied. Element 10: wherein the backoff value is incremented using an algorithm specified by the yield parameter. Element 11: wherein the backoff value is reset to an initial value at a time when an N-threshold parameter is exceeded. Element 12: wherein the set of one or more yield occasionally instructions uses an operating parameter of the processing unit or a yield parameter specified within the code block to determine the decision algorithm to utilize with the set of one or more yield occasionally instructions. Element 13: wherein the decision algorithm counts a number of times a specified instruction is encountered in the code block during execution of the thread. Element 14: Wherein the decision algorithm performs the yield operation after the count exceeds a threshold. Element 15: Wherein the decision algorithm resets the count. Element 16: wherein the compiler uses input from the code or the operating parameters to determine the position. Element 17: wherein the processing unit detects a looping code block and the processing unit inserts the set of one or more yield occasionally instructions within the looping code block. Element 18: the processing unit is a graphics processing unit. Element 19: wherein the code specifies a guarantee of forward progress for each spawned thread. Element 20: wherein the yield parameter is specified by a decision algorithm or specified by the code. Element 21: wherein the yield parameter specifies the one or more yieldocc instructions execute the yield operation after a specified number of times the one or more yieldocc instructions are executed or after a specified amount of time, where a count of the specified number is reset to zero at a time when the yield operation is executed. Element 22: wherein the yield parameter specifies the one or more yieldocc instructions execute the yield operation when a randomly generated result satisfies the yield parameter. Element 23: wherein the yield parameter specifies the one or more yieldocc instructions execute the yield operation after a backoff value is satisfied. Element 24: wherein the backoff value is incremented using an algorithm specified by the yield parameter. Element 25: wherein the set of one or more yield occasionally instructions is implemented using one or more yieldocc instructions with one or more yield parameters. Element 26: wherein the set of one or more yield occasionally instructions is simulated with a set of processing unit instructions using one or more yield parameters. Element 27: wherein the one or more instructions are inserted into the code during the compiling when a yield operation of the code is uncertain to occur. Element 28: wherein the one or more instructions are a set of one or more yield occasionally instructions.

What is claimed is:

1. A method, comprising:
compiling code for a targeted processing unit, wherein the code spawns a greater number of threads than can be executed simultaneously by the targeted processing unit;
inserting a set of one or more yield occasionally instructions into the code during compilation when a termination of the code is uncertain, wherein the set of one or more yield occasionally instructions cause a thread in which the set of one or more yield occasionally instructions are executing to perform a yield operation at a yield interval as directed by a yield parameter; and
generating, using the compiling code and the set of one or more yield occasionally instructions, a final compiled code for the targeted processing unit.

2. The method as recited in claim 1, wherein the set of one or more yield occasionally instructions is a single code instruction.

3. The method as recited in claim 1, wherein the yield operation is simulated by code when not supported by the targeted processing unit.

4. The method as recited in claim 1, wherein the yield parameter is specified by a decision algorithm.

5. The method as recited in claim 1, wherein the yield parameter specifies the set of one or more yield occasionally instructions execute the yield operation after a specified number of times the set of one or more yield occasionally instructions are executed, where a count of the specified number is reset to zero when the yield operation is executed.

6. The method as recited in claim 1, wherein the yield parameter specifies the set of one or more yield occasionally instructions execute the yield operation after a specified amount of time has elapsed, where a count of the specified number is reset to zero when the yield operation is executed.

7. The method as recited in claim 1, wherein the yield parameter specifies the set of one or more yield occasionally instructions execute the yield operation after a specified number of times a specified instruction is encountered in the code, where a count of the specified number is reset to zero when the yield operation is executed.

8. The method as recited in claim 1, wherein the yield parameter specifies the set of one or more yield occasionally instructions execute the yield operation when a randomly generated result satisfies the yield parameter.

9. The method as recited in claim 1, wherein the yield parameter specifies the set of one or more yield occasionally instructions execute the yield operation after a backoff value is satisfied, wherein the backoff value is incremented using an algorithm specified by the yield parameter.

10. The method as recited in claim 9, wherein the backoff value is reset to an initial value at a time when an N-threshold parameter is exceeded.

11. A processing unit, comprising:
a thread management system, capable of executing at least one more thread than the processing unit is able to process simultaneously;
a code execution system, capable of analyzing execution of a code block on each thread of the thread management system and determining if a locking thread of the thread management system exceeds a specified number of loops or a specified number of processing cycles while not releasing thread control; and
a code modification system, capable of inserting a set of one or more yield occasionally instructions at a position within the code block being executed by the locking thread, wherein the set of one or more yield occasionally instructions will occasionally perform a yield operation on the locking thread, as determined by a decision algorithm.

12. The processing unit as recited in claim 11, wherein the set of one or more yield occasionally instructions uses an operating parameter of the processing unit or a yield parameter specified within the code block to determine the decision algorithm to utilize with the set of one or more yield occasionally instructions.

13. The processing unit as recited in claim 11, wherein the decision algorithm counts a number of times a specified instruction is encountered in the code block during execution of the thread, and performs the yield operation after the count exceeds a threshold and resets the count.

14. A system, comprising:
a processing unit capable of executing compiled code blocks using more threads than the processing unit is capable of running simultaneously; and
a compiler, capable of compiling code to run on the processing unit, receiving operating parameters of the processing unit, and inserting a set of one or more yield occasionally instructions into the code at positions determined by the compiler, wherein the operating parameters indicate that the processing unit does not guarantee forward progress for each thread, the set of one or more yield occasionally instructions specifies a yield operation is to be performed at a yield interval, and code blocks where the positions are located are non-terminating regions or regions that are uncertain to terminate.

15. The system as recited in claim 14, wherein the compiler uses input from the code or the operating parameters to determine the position.

16. The system as recited in claim 14, wherein the processing unit detects a looping code block and the processing unit inserts the set of one or more yield occasionally instructions within the looping code block.

17. The system as recited in claim 14, wherein the processing unit is a graphics processing unit.

18. The system as recited in claim 14, wherein the code specifies a guarantee of forward progress for each spawned thread.

19. A computer program product having a series of operating instructions stored on a non-transitory computer-readable medium that directs a compiler when executed thereby to perform operations for compiling code, the operations comprising:
receiving operating parameters of a processing unit, wherein the processing unit is capable of processing more threads than can be run simultaneously on the processing unit;
compiling the code for the processing unit, wherein the code will spawn a greater number of threads than can be executed simultaneously by the processing unit;
inserting a one or more yieldocc instructions into the code during compilation when the code is known to not terminate its processing thread, or the code is uncertain to terminate its processing thread, wherein the one or more yieldocc instructions cause a thread in which the one or more yieldocc instructions are executing to execute a yield operation at a yield interval as directed by a yield parameter; and
generating, using an output of the compiling and the inserting, a final compiled code capable of being executed on the processing unit.

20. The computer program product recited in claim 19, wherein the yield parameter is specified by a decision algorithm or specified by the code.

21. The computer program product as recited in claim 19, wherein the yield parameter specifies the one or more yieldocc instructions execute the yield operation after a specified number of times the one or more yieldocc instructions are executed or after a specified amount of time, where a count of the specified number is reset to zero at a time when the yield operation is executed.

22. The computer program product as recited in claim 19, wherein the yield parameter specifies the one or more yieldocc instructions execute the yield operation when a randomly generated result satisfies the yield parameter.

23. The computer program product as recited in claim 19, wherein the yield parameter specifies the one or more yieldocc instructions execute the yield operation after a backoff value is satisfied, wherein the backoff value is incremented using an algorithm specified by the yield parameter.

24. A processing unit system, comprising:
a thread management system, capable of executing at least one more thread than a processing unit is able to process simultaneously;
a code execution system, capable of analyzing, during a runtime processing of the processing unit, a code block on at least one thread of the thread management system to determine if the code block is causing a locking thread of the thread management system, wherein the locking thread exceeds a specified number of loops or a specified number of processing cycles while not releasing thread control; and
a runtime modifier system, capable of inserting a set of one or more yield occasionally instructions at a position within the code block of the locking thread, wherein the set of one or more yield occasionally instructions will occasionally perform a yield operation on the locking thread, as determined by a decision algorithm.

25. The processing unit system as recited in claim 24, wherein the set of one or more yield occasionally instructions is implemented using one or more yieldocc instructions with one or more yield parameters.

26. The processing unit system as recited in claim 24, wherein the set of one or more yield occasionally instructions is simulated with a set of processing unit instructions using one or more yield parameters.

27. A method, comprising:
compiling code for a targeted processing unit, wherein the code spawns a greater number of threads than can be executed simultaneously by the targeted processing unit and the compiling code includes one or more instructions in one of the threads that cause the one of the threads to conditionally perform a yield operation at a yield interval as directed by a yield parameter; and
generating, using the compiling code and the one or more instructions, a final compiled code for the targeted processing unit.

28. The method as recited in claim 27, wherein the one or more instructions are inserted into the code during the compiling when a yield operation of the code is uncertain to occur.

29. The method as recited in claim 27, wherein the one or more instructions are a set of one or more yield occasionally instructions.
